(19) United States
(12) Patent Application Publication
(10) Pub. No.: US 2009/0007800 A1
(43) Pub. Date: Jan. 8, 2009

(54) Rotisserie

(75) Inventor: Steven Maroti, Fort Lee, NJ (US)

Correspondence Address: NORRIS, MCLAUGHLIN & MARCUS, P.A., 875 THIRD AVE, 18TH FLOOR, NEW YORK, NY, 10022, US

(73) Assignee: HICKORY INDUSTRIES, INC., North Bergen, NJ (US)

(21) Appl. No.: 11/908,725

(22) PCT Filed: Mar. 13, 2006
(86) PCT No.: PCT/US2006/008924

§ 371 Date: May 5, 2008

Related U.S. Application Data
(60) Provisional application No. 60/661,388, filed on Mar. 14, 2005.

(51) Int. Cl. A47J 37/04

(52) U.S. Cl. 99/421 HV; 99/420; 99/421 H

(57) ABSTRACT

A rotisserie cooking apparatus has at least one cooking rod for holding food to be cooked. Each rod has at each end a guide element, which is preferably in the form of a wheel or geared wheel. A frame of the apparatus supports an inclined guide path at either lateral side thereof for receiving the guide elements for each rod and guiding the rod gravitationally from an entry point downward towards an exit point of the guide path. The guide element and guide path are structured to cause an axial rotation of the rod as it travels down the guide path, preferably by way of gear rack in the guide path that corresponds to the gear teeth of the guide element wheel. The speed of the rod down the incline path is controlled, preferably by way of a tension or friction force against a later wall of the guide path. A preferable structure provides for a tension element at the end of the rod, which is axially adjustable to provide for differing frictional forces against the lateral wall. The apparatus may additionally have a rod loading arrangement for automatically transferring rods onto the guide path, which rod loading arrangement has a storage rack for holding a plurality of horizontally oriented rods vertically spaced-apart from each other at rod storage locations. At least one vertically oriented continuous belt loop is rotatable about a lower and an upper pulley means, the belt loop having a plurality of spaced-apart lifting fingers projecting outwardly and perpendicularly from the belt loop for lifting rods from the rod storage locations and transporting them to the guide path. The belt loop is located such that rods lifted from the storage rack and carried upwards by the lifting fingers, up to and around the upper pulley, are deposited onto the guide path at the entry point thereof.

### BACKGROUND OF THE INVENTION

1. Field of the Invention

The present invention relates to a rotisserie cooking apparatus for whole chickens or the like. More particularly, the invention relates to a rotisserie having multiple rotating cooking spits which move gravitationally down an inclined path at a controlled pace. The invention also comprises a roll-up, refrigerated or insulated food storage unit, which interacts with the rotisserie to provide automatic loading of spits onto the rotisserie.

2. Discussion of the Prior Art

Existing rotisserie cooking apparatus are available, which can simultaneously cook multiple food items on a spit, and which can handle multiple spits. Particularly in the case of mass market food outlets, such as open-kitchen restaurants or supermarkets, such rotisseries are often in the form of a vertically-oriented, glass-walled cabinet. A heat source is provided, usually from the inside rear wall of the enclosed cabinet. The spit rods rotate and/or move orbitally in order to provide even cooking. The rotation and orbital movement of the rods is performed usually by a set of appropriate gears, powered by one or more motors. While quality cooking may be performed in such an apparatus, it suffers from several drawbacks. First, its complex nature involving motors and interlocking gears leads to difficult in repairs. The cabinet must be opened, by way of its doors, to remove the spits. In addition to releasing heat from the cabinet, the orbiting motion of the other spits must be stopped. Also, even though there may be glass doors, they are often covered with steam, so that the product is not clearly visible; and the enticing aroma and cooking sound is contained within the cabinet, rather than being available to attract customers.

U.S. Pat. No. 5,974,956 to McConnell teaches a rotisserie which has a housing or which may be open-air. The spits reside for a set time period within discrete cooking stations located along an incline. At each station, the spits engage and are rotated by a continuous drive chain; and the chickens are cooked by lateral pairs of heating elements. The spits are moved from station to station periodically, by way of a complex cam shaft mechanism. Piston drive draws a shaft horizontally in the direction of the incline. As it draws in, cams force rods upward. The rods push up on the spits, forcing them out of their stationary slots, and up onto the incline surface. At that point, the spits then roll gravitationally down the incline and drop into the next stationary slot, where they are engaged by the chain, and reside in rotating fashion until the next cam motion. The loading is effected by a specially formed cam rod which releases the next spit and allows it to roll into the first station.

U.S. Pat. No. 2,142,390 to Kerr relates to a hot dog cooking apparatus. Even though this device uses spit rods, it is essentially limited to hot dogs or other like foods, and is not adaptable to cooking irregularly shaped foods such as whole chickens. A feeder mechanism is shown in FIG. 3, based on a feeder ramp 76. Because of the shape of the hot dogs, they can reside laterally against one another, and roll gravitationally with direct contact onto the lifting wheel, where the rods are engaged by teeth 72 and dropped into slots 70. Once pulled into the cooking area, the hot dog rods rotate in a semi-circle around the wheel, and are cooked by a heating element below. The wheel is turned by a motor. As shown in FIG. 5, a sprocket 92 on each rod is engaged by a corresponding rack 98, in order to rotate the spits as they orbit the cooking element.

U.S. Pat. No. 1,665,225 to Simek relates to an incline, gravity fed corn roaster. Ears of corn are paired end to end by way of a linking rod 12, and fed onto incline entry 6. By force of gravity, the corn rolls down the incline 5, against each other. The rotating of the corn is effected by way of a mesh support on the incline, which frictionally acts against the corn itself. A finger mechanism 10 on a rotatable shaft 9 allows for the control of the timing down the incline, as it shifts corn at the bottom off the incline 7, which then allows the remaining corn to continue rolling down. While this apparatus is non-mechanized, and effects a rotation of the food while allowing for gravity fed movement down the incline as it cooks, it does not applicable to the cooking of whole chickens on spit rods, as these will not roll down an incline in a controllable fashion, and certainly can not roll against each other.

It is therefore an object of the invention to provide a rotisserie with a minimum of moving parts, and without the need for motors to effect rotation of the spits or movement of the spits with respect to the rotisserie cabinet.

It is a further object of the invention to provide an open-air rotisserie which can handle multiple spits, while allowing unobstructed view of the product being cooked.

It is a still further object of the invention to provide a rotisserie which can be continuously loaded and unloaded, either manually or by automatic means, without interrupting the rotisserie operation.

### SUMMARY OF THE INVENTION

Accordingly, there is provided a rotisserie cooking apparatus has at least one cooking rod for holding food to be cooked. Each rod has at each end a guide element, which is preferably in the form of a wheel or geared wheel. A frame of the apparatus supports an inclined guide path at either lateral side thereof for receiving the guide elements for each rod and guiding the rod gravitationally from an entry point downward towards an exit point of the guide path. The guide element and guide path are structured to cause an axial rotation of the rod as it travels down the guide path, preferably by way of gear rack in the guide path that corresponds to the gear teeth of the guide element wheel. The speed of the rod down the incline path is controlled, preferably by way of a tension or friction force against a later wall of the guide path. A preferable structure provides for a tension element at the end of the rod, which is axially adjustable to provide for differing frictional forces against the lateral wall. The apparatus may additionally have a rod loading arrangement for automatically transferring rods onto the guide path, which rod loading arrangement has a storage rack for holding a plurality of horizontally oriented rods vertically spaced-apart from each other at rod storage locations. At least one vertically oriented continuous belt loop is rotatable about a lower and an upper pulley means, the belt loop having a plurality of spaced-apart lifting fingers projecting outwardly and perpendicularly from the belt loop for lifting rods from the rod storage locations and transporting them to the guide path. The belt loop is located such that rods lifted from the storage rack and carried upwards by the lifting fingers, up to and around the upper pulley, are deposited onto the guide path at the entry point thereof.

### BRIEF DESCRIPTION OF THE DRAWINGS

FIG. 1 is a front perspective view of the rotisserie cabinet of the invention, with optional roll-up storage unit, having cooking chickens thereon.

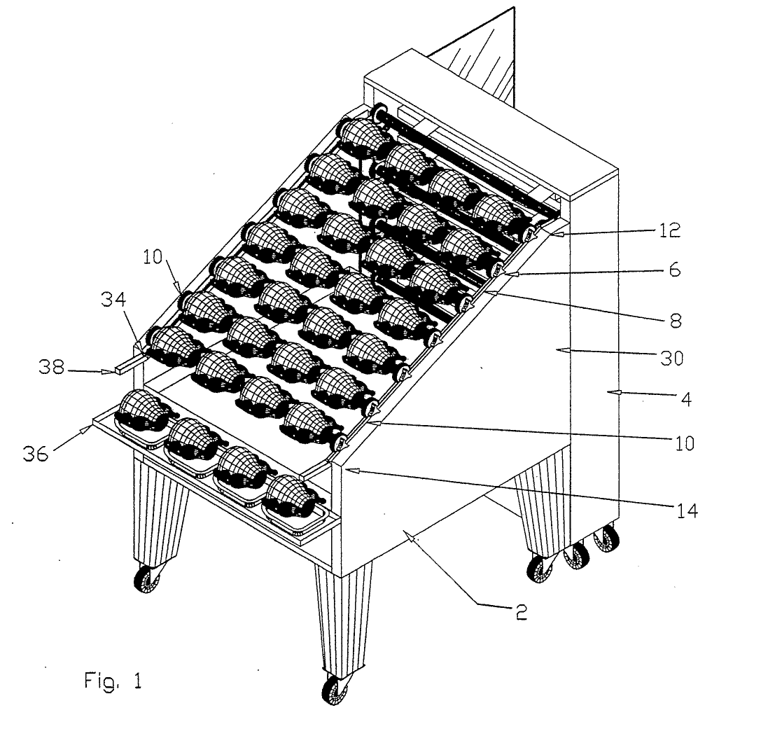

FIG. 2 is a rear perspective view of FIG. 1.

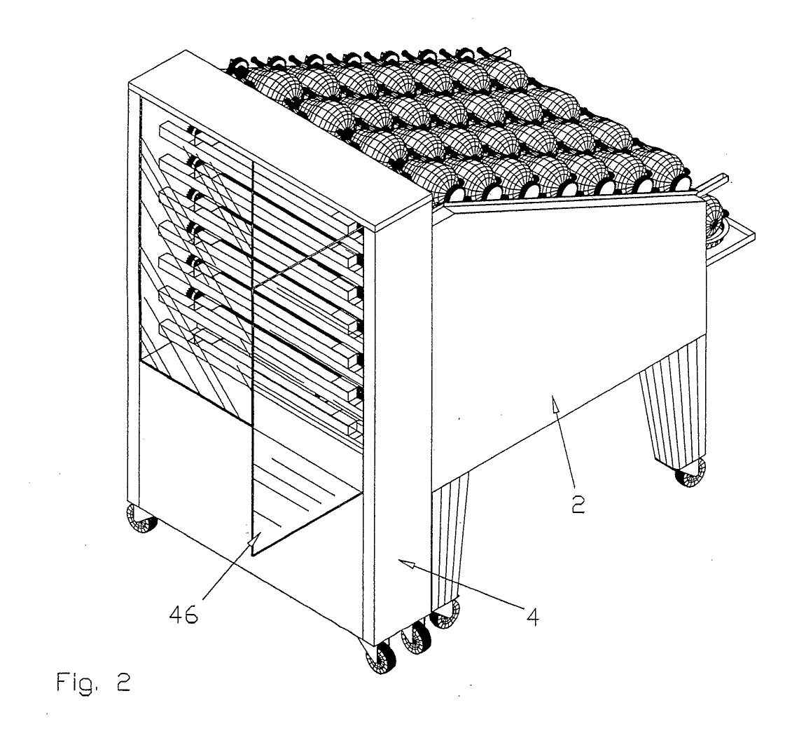

FIG. 3 is a side, schematic view of FIG. 1.

FIG. 4 is rear perspective view of the rotisserie cabinet of the invention, without cooking spits.

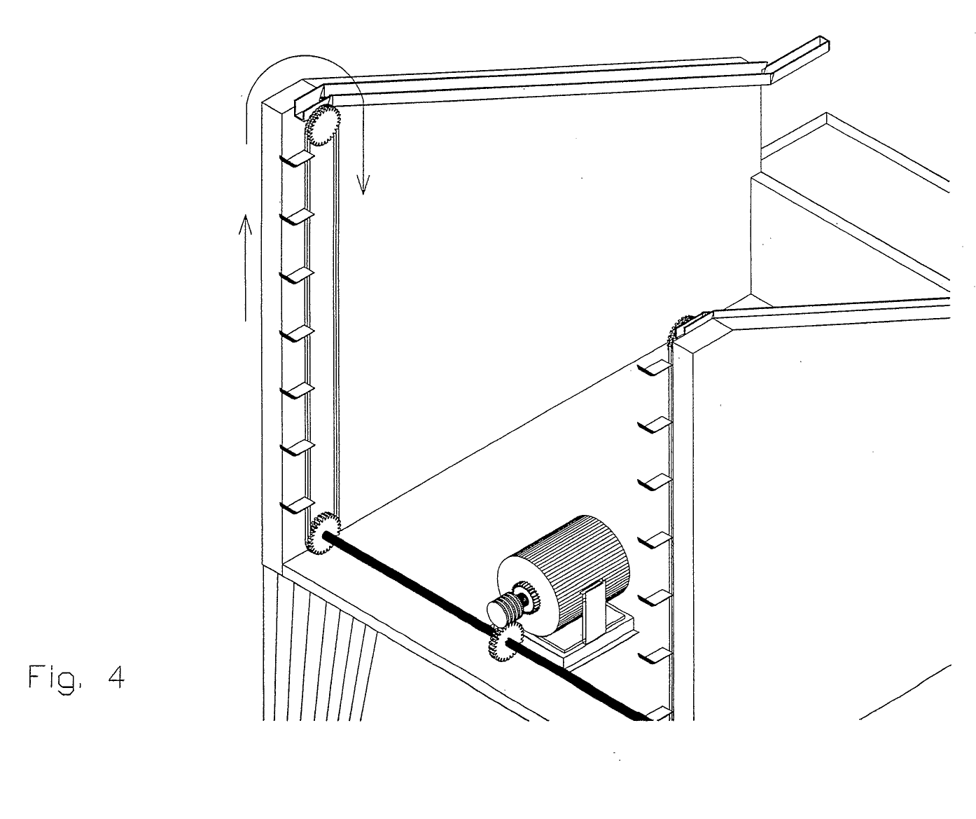

FIG. 5 is a rear perspective close-up view of a right, rear portion of the invention, with storage unit and cooking spits.

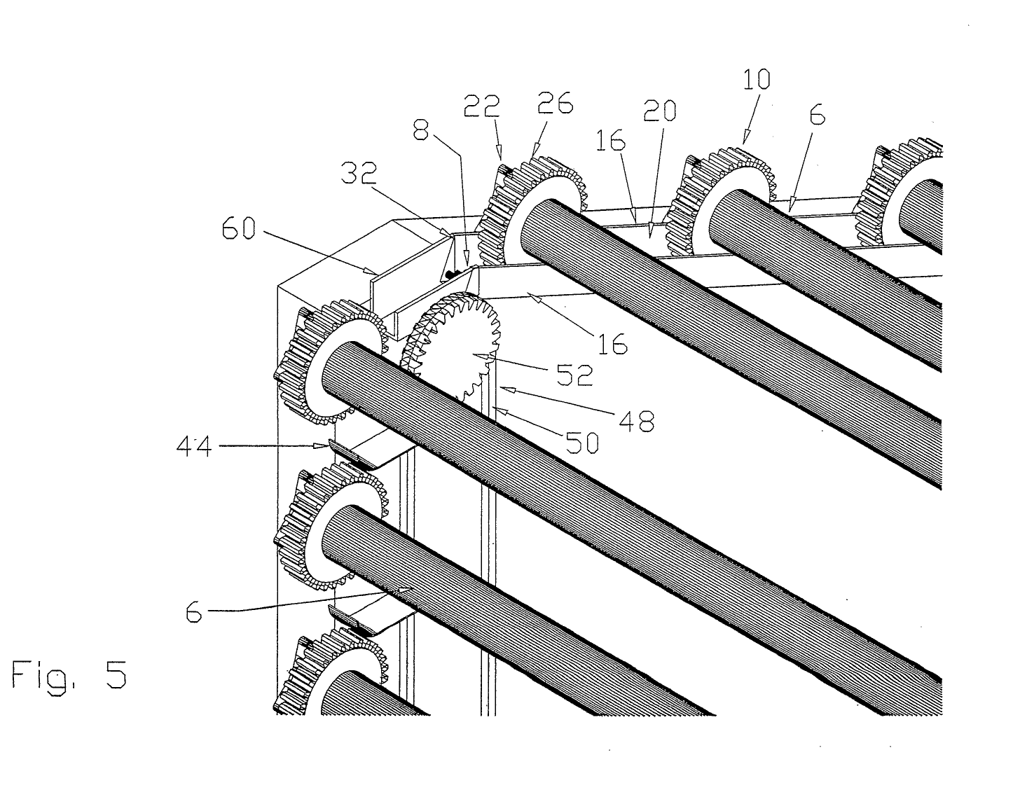

FIG. 6 is a top plan view of the rear portion of the invention as shown in FIG. 5.

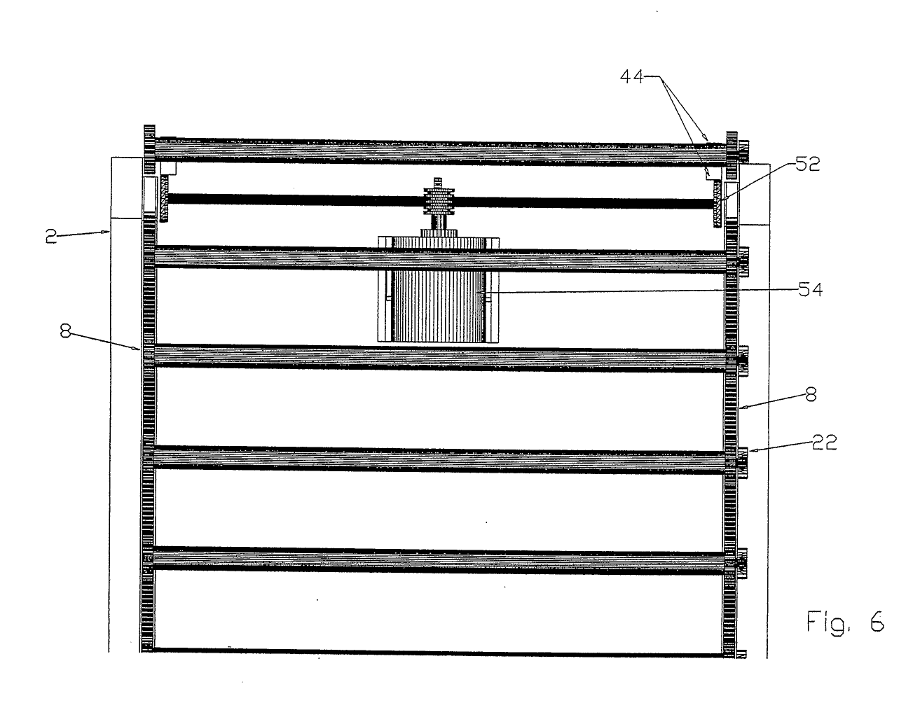

FIG. 7 is a front perspective close-up view of a right, rear portion of the invention as shown in FIG. 5.

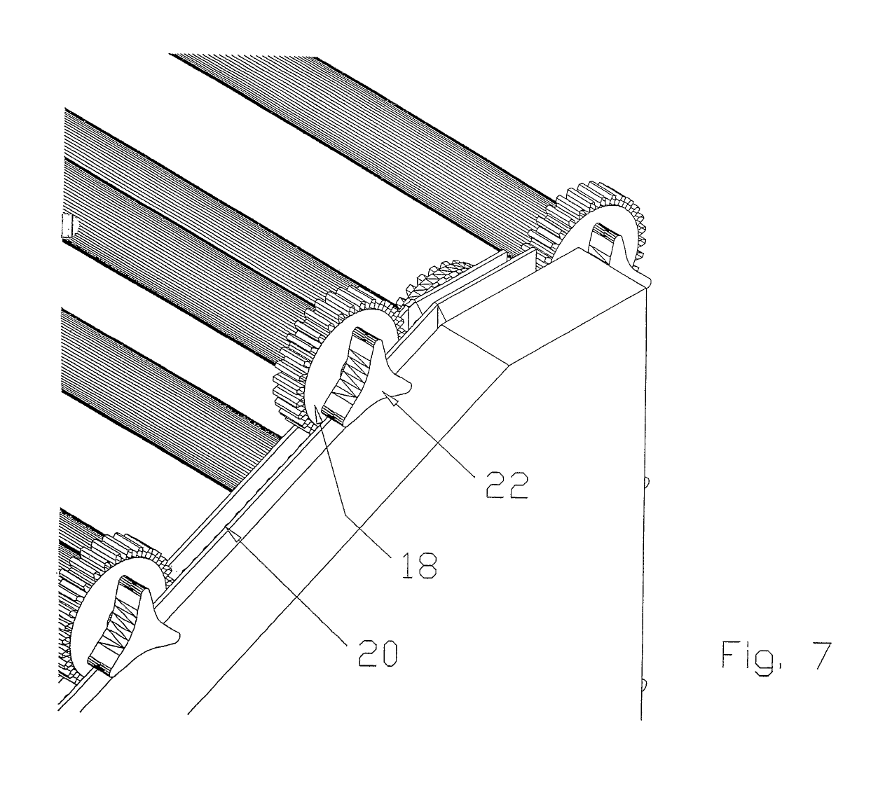

FIG. 8 is a front perspective close-up view of a left, rear portion of the invention as shown in FIG. 5.

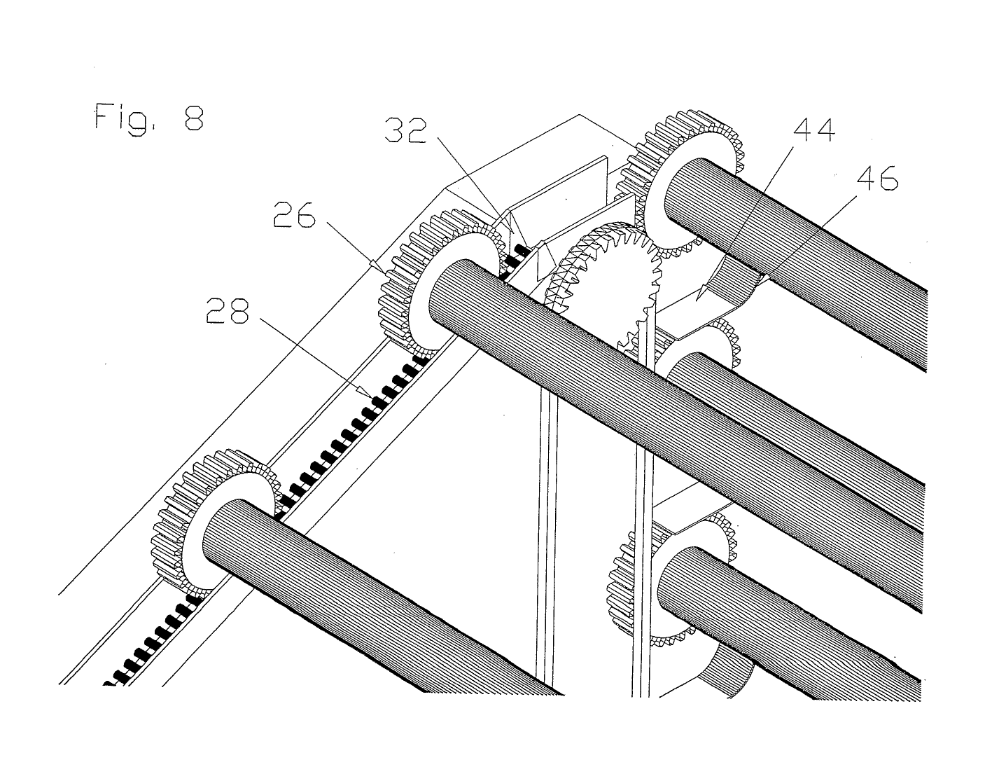

FIG. 9 is view of FIG. 7 from an alternate angle.

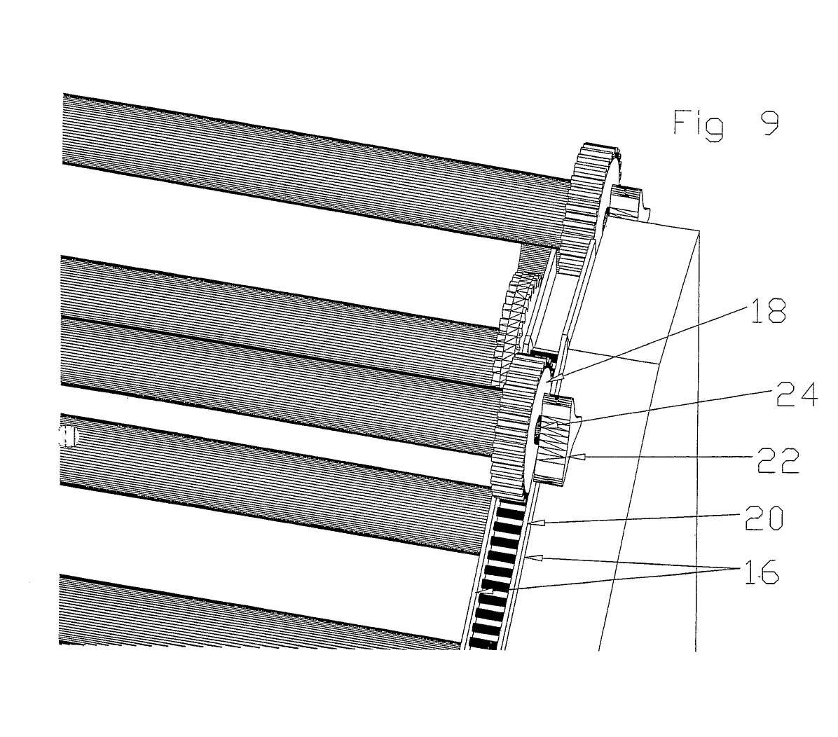

FIG. 10 is a side, schematic view of the rotisserie cabinet showing an exemplary arrangement of heating elements.

FIG. 11 is a perspective view of a front of a storage cabinet of the invention.

FIG. 12 is a top view of a storage cabinet brought into arrangement with a rear portion of the rotisserie cabinet.

### DETAILED DESCRIPTION OF THE INVENTION

A rotisserie frame 2, being in the form of an open cabinet or simply a support structure, is provided for supporting a plurality of cooking rods or spits 6. Each rod 6 has a guide element 10 on each end, such as a gear or wheel, removably fixed against rotation with respect to the rod. The guide elements are arranged coaxially to and with a larger diameter than the rod. It is also possible that the guide element is integral with the rod, though it should be sized to allow for insertion and removal of the rod through the food. A parallel pair of guide paths 8 is provided, on either lateral side of the cabinet, running from the rear 12 of the cabinet, at a downward incline toward the front 14 of the cabinet. The guide elements and guide paths are sized and shaped to cooperate, such that a rod, in a preferred embodiment having gears as guide elements, rides gravitationally down the guide paths provided formed as a conforming gear rack. A preferred form of a gear is a sprocket gear, well known in the art, which is structured to have teeth 26 with a generally flat top, and rounded edges falling away form the top to allow for a smooth, relatively vibration free transfer of power. The gear rack 28 would be a conforming, female version of the gear, or a series of spaced apart lateral pins, as is known in the art.

The guide path 8 has a vertically oriented side wall 16 on either or both lateral sides of the guide path to retain the rod against lateral movement. While a simple wheel and flat path may be used as the guide element and path, respectively, it can be seen that the use of a gear and rack system is advantageous in that, as the rod rolls down the incline path due to gravity, the meshing of the teeth of the gear and rack simultaneously cause a controlled rotation of the rod.

It is important that the speed of the rods down the path be controlled in order to insure complete cooking of the food on the rod. The speed may be most readily controlled by a frictional resistance between at least one of the lateral faces 18 of the gear and the inside face 20 of the guide path side wall 16. By forcing the gear to ride frictionally against the inside face of the wall, a fit can be provided which allows for gravitational rolling of the rods down the path, but which nevertheless provides a controlling resistance, in order to slow the rotation and allow for sufficient cooking time. In this regard, as a means for controlling the speed, it is preferred that a tensioner mechanism 22 be provided for adjacent one of the outside faces of the gear, preferably the outside face. The tensioner is connected to the gear in a manner which allows for an axial, lockable adjustment, preferably by manual operation, of the distance between the inside face of the tensioner and the outside face of the gear. The tensioner is preferably positioned coaxially with the rod, with a connection by way of a connecting axle 24 in the form of a screw means or the like. In addition, at least the outside wall of the guide path should have a height which should be lower than the height of the connecting axle when the rod is residing in the guide path, so as not to interfere with the rolling motion of the rod. In this arrangement, the outside wall of the guide path also acts a friction plate, which will be squeezed between the opposing faces of the tensioner and the gear. By adjusting the distance between the two faces, the amount of tension or friction exerted against the friction plate can be adjusted, which in turn controls the speed at which the rod can gravitationally roll down the inclined guide path.

Other means for controlling the speed of rolling would include providing at least one of the lateral walls of the guide path as being adjustable with respect to the distance between the two walls, so as to effect an adjustable friction of the two inner wall faces against the two outer faces of the gear. Other methods can be employed to control the speed of the rods, such as a calibrated clutch brake mechanism, or a ratchet mechanism or cam system based on interacting elements provided on the gear and the lateral walls of the guide path.

The guide paths are provided preferably along the top edges of two side walls 30 of the cabinet. If it is desired that the rotisserie be open on the sides as well, the guide paths can also be supported by appropriate support posts, or on the front or rear walls of the cabinet. The entry point 32 to each guide path 8 is open towards the rear of the cabinet, to allow for intake of the gear or guide element 10. The entry point may be characterized by a slight flaring out of one or both lateral walls of the guide path, to assist in loading the rod. The end 34 of each guide path is open towards the front of the cabinet, such that when each rod reaches the end of the path, it will automatically exit the cooking area. In one embodiment, a generally horizontal shelf path 38 is provided immediately forward of and below the exit point, so that the rod simply rolls off and drops down onto the shelf path, waiting for further manual attention. Below the shelf path may be a shelf 36, which can be used to support pre-positioned receptacles. It is also possible to provide a further gravitationally fed ‘waiting area’, away from the cooking area, where rods bearing the cooked food can be stored until removal by an operator. Or, an automated retrieval system, possibly of a roll-away type, can be provided adjacent the end of the guide paths, to aid in withdrawal of the rods from the cabinet.

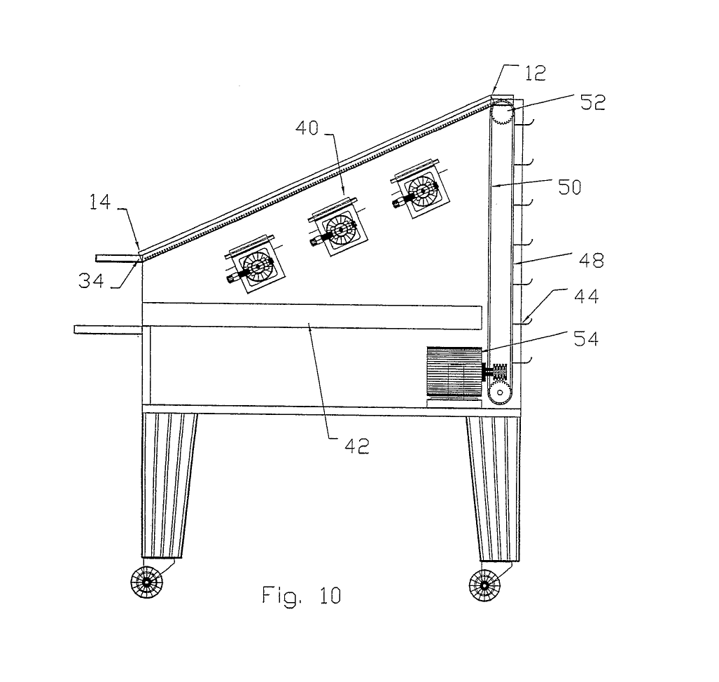

The food is cooked from beneath, by any known means. This may include coal, gas burners, electric coils or the like; and would have all necessary protectors for dealing with drippings, flare-ups, etc. FIG. 10 shows an exemplary design for a heating means, such as a series of gas burners 40 located in spaced-apart arrangement along the length of the guide path, in an arrangement parallel to the plane of the guide path. However, the choice and layout of heating elements, as well as the proper heating temperature and time, can be chosen by the skilled person. A drip pan filled 42 with water may be provided at the bottom of the casing to prevent flare ups. The degree of incline of the guide paths is chosen so as to provide a balance between for sufficient speed control between the gravitational and frictional forces, while providing a clear frontal view of all of the food being cooked. The dimensions and parameters will be selected by the skilled person to provide sufficient heat and cooking time. Strictly as a non-limiting example, an incline of about 25 degrees above horizontal may be used, with a guide path length of about 48-50 inches. Gas burners may be positioned at about 12 inches below the guide path, and the tensioners may be adjusted to allow for a residence time of 30-60 minutes.

It can be seen from the above description that the rotisserie of the invention is unique in providing a system which both rotates the rods and moves the rods with respect to the cabinet, while allowing continuous loading and unloading, without the need for external motors or other external mechanical forces.

While the rotisserie itself is free of mechanization, an optional loading apparatus may be provided for use in conjunction with the rotisserie. In order to provide a ready supply of food to the rotisserie, a stand-alone, preferably roll-away, and preferably refrigerated or insulated storage cabinet 4 is provided. To provide a compact arrangement, a vertical orientation is preferred, wherein a plurality of rods 6 pre-loaded with food to be cooked such as raw whole chickens, rest on corresponding sets of fingers or other rod support elements (not shown), forwardly protruding from a rear wall or support frame. The fingers preferably are structured to retain the rods against forward roll-off, either by being angled upwardly, or by way of an upwardly oriented retaining abutment.

The storage cabinet may be simply in the form of an open vertical rack which can be moved, or wheeled, up to the rear of the rotisserie cabinet. In a preferred embodiment, the storage cabinet is closed, with doors 46 opening in the rear to allow loading of the rods, and still further preferred, is refrigerated or insulated to prevent spoilage during a waiting period prior to loading.

An automatic rotisserie loading device is provided for use in conjunction with the storage cabinet. Such loading device may be provided as part of the rotisserie cabinet as shown, or as part of the storage cabinet. The loading device 48 comprises at least two sets of vertically oriented belts 50 or chains, laterally spaced apart, each rotatable around at a set of at least two pulleys 52 or chain drive wheels, lower pulley located below the lowest rod support in the storage cabinet, and an upper pulley. At least one pulley is connected to a drive means, such as a motor 54 or possibly a hand operated drive crank, for example by way of drive shaft. Preferably, the motor turns a drive shaft which connects to pulleys on either lateral side, for synchronous driving. The drive means 54 is calibrated to rotate the belt at a speed which will load the rods onto the rotisserie at the desired rate. The upper pulley is located at a height, such that a top edge of a rod transfer element is essentially parallel to or only slightly above the level of the entry point into the guide path. Additionally, the loading device is structured and positioned such that the rod transfer element is properly aligned with the entry point of the guide rail to allow for a smooth transfer of the rod from the storage cabinet onto the guide rail.

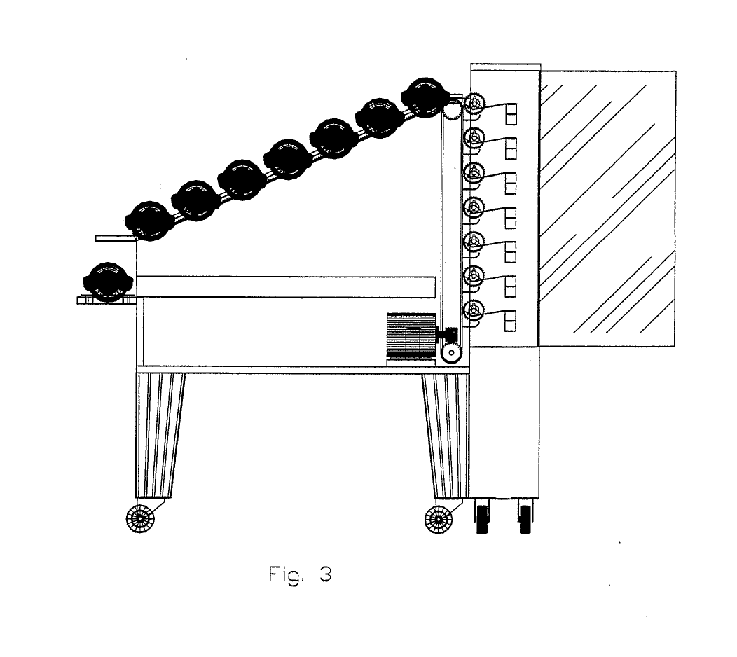

Protruding radially from each belt is a series of lifting fingers 44, spaced vertically from each other at a distance corresponding to the distance between the rods resting in the storage cabinet. The lifting fingers should be sufficiently strong and should be fixed to the belt in such as way as to be able to lift and support a rod with upward movement as the belt rotates. The lifting fingers on each belt should be arranged so that corresponding level pairs of lifting fingers are provided. Viewing the rotisserie from the side with the front of the rotisserie cabinet on the left (as in FIG. 3), the belt will rotate counter-clockwise to lift and load the rods.

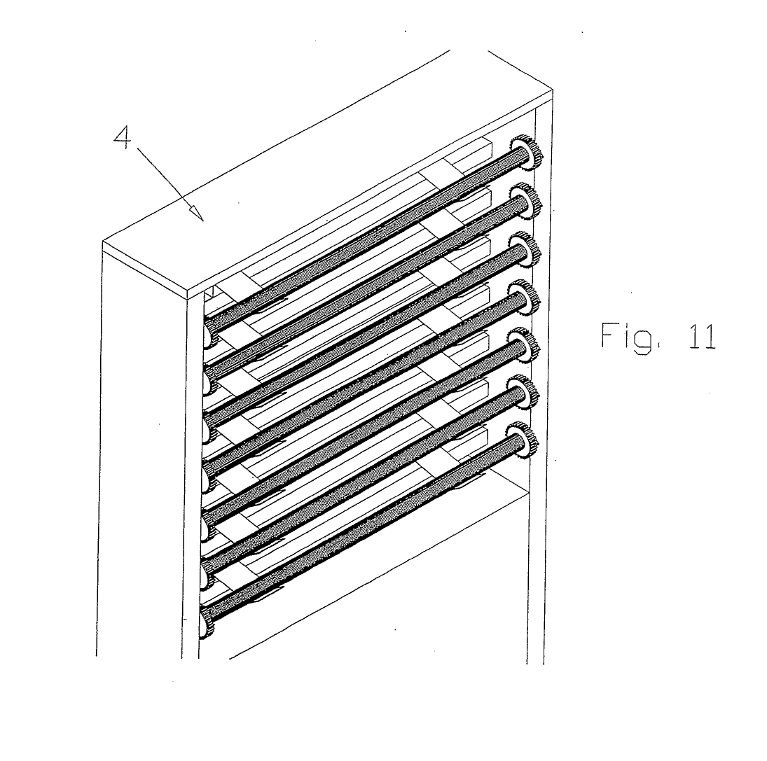

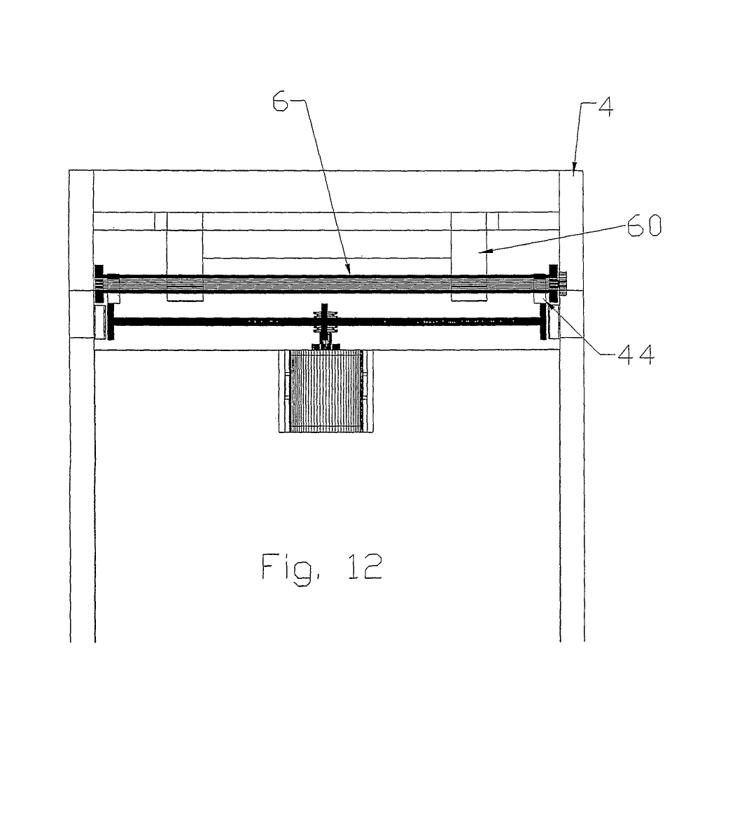

With reference to FIGS. 11 and 12, in order to allow a transfer of the rod from the storage cabinet 4 to the lifting fingers 44, an arrangement must be provided such that the mechanism for holding the rods in the storage rack does not interfere with upward movement of the lifting fingers. One such arrangement relies on sets of two (or possibly more) storage fingers 60 projecting generally forward from the rear of the storage rack, arranged in parallel, with each group being spaced apart vertically to correspond to the spacing of the lifting fingers. The storage fingers should be angled slightly upward from the horizontal (or may be generally horizontal with an upwardly curving free end) so that the rods 6 resting on the storage fingers are retained against premature forward roll off. The storage fingers should be laterally offset from the lifting fingers. The storage fingers are structured so that the spit rods reside thereon in a location which allows for transfer to the lifting fingers when the lifting fingers move upwardly. In other words, the spit rods reside on the storage fingers at a location which intersects with the vertical lifting plane of the lifting fingers. As the transferred spit rod being carried upward by the lifting fingers will then contact the projecting storage fingers, the storage fingers are provided with a deflecting mechanism, such as a hinge, which allows the storage fingers to be deflected upward, rotating toward the rear of the storage cabinet. A spring may be provided to bias the storage fingers back to storage position; and an abutment or support may be provided below to supportingly retain the storage fingers in storage position.

As the rod is being lifted by the lifting fingers, it will approach the top of the belt loop path and will be brought up and around the upper pulleys 52. The lifting fingers 44 have a retaining structure on the ends thereof, preferably an upwardly curved end structure 46. As the rod shifts from an upward force to a forward force as the belt rounds the upper pulleys, the retaining structure on the end of the lifting fingers acts against the centripetal force, and aids in carrying the rod up and around toward the guide path. As the lifting fingers, carried by the belt loop, round the top of the gear or pulley and begin a downward path, the rods roll of the lifting fingers and are dropped into the guide path. Alternatively, the rods may be transferred to an intermediate transfer path 60 located proximal to and in line with the start of the guide path, to insure a smooth transfer.

This sequence continues until each of the rods in the storage cabinet have been transferred to the rotisserie. The speed of the belt should be set so that the loading rate corresponds to the throughput rate of the rods on the rotisserie itself, to provide steady-state operation. The spacing between the belt loop and the start of the guide path, as well as the retaining structure of the lifting fingers, as in the case of an upwardly curved end region, should be so formed to allow for roll-off the rods in a manner that the fingers do not interfere with the rod as they begin their downward path along the belt. After all of rods from the storage cabinet have been loaded onto the rotisserie, the storage cabinet may be moved away from the rotisserie, and re-stocked.

What is claimed is:

1. A rotisserie cooking apparatus, comprising:
at least one cooking rod for retaining thereon food to be cooked, the rod having at each end a guide element,
an inclined guide path supported by a frame at either lateral side thereof for receiving the guide elements for each rod and guiding the rod gravitationally from an entry point downward towards an exit point of the guide path, the guide element and guide path being structured to cause an axial rotation of the rod as it travels down the guide path, and
means for controlling the speed of the rod in relation to the guide path.

2. The apparatus of claim 1, wherein the guide element is a removable wheel coaxially fixed against rotation to the rod end, the wheel having a diameter larger than that of the rod.

3. The apparatus of claim 2, wherein the wheel is a gear.

4. The apparatus of claim 3, wherein the wheel is a sprocket gear.

5. The apparatus of claim 3, wherein a bottom surface of the guide path which supports the gear thereon comprises a conforming gear rack.

6. The apparatus of claim 1, wherein the guide path has at least one lateral wall, spaced such that an inner face of the outer wall imparts a frictional force against an outer edge face of the guide element when the rod is located in the guide path.

7. The apparatus of claim 6, wherein the means for controlling the speed is a tension element coaxially attached to the rod and/or gear by way of the outer edge face of the guide element, which tension element is adjustable axially with respect to the outer edge face of the guide element to provide an axial space between the outer edge face of the guide element and an inner face of the tension element, wherein the lateral wall may reside within the axial space when the rod is located in the guide path, which two faces may be adjustably brought into frictional contact with the respective inner and outer faces of the lateral wall of the guide path.

8. The apparatus of claim 1, further comprising a rod loading arrangement for automatically transferring rods onto the guide path, the rod loading arrangement comprising a storage rack for holding a plurality of horizontally oriented rods vertically spaced-apart from each other at rod storage locations, at least one vertically oriented continuous belt loop rotatable about a lower and an upper pulley means, said belt loop bearing thereon a plurality of vertically spaced-apart lifting fingers projecting outwardly and perpendicularly from the belt loop for lifting rods from the rod storage locations and transporting them to the guide path, the vertical spacing between the lifting fingers corresponding to that between the rod storage locations in the storage rack, said belt loop running from a point at or below a lowest rod storage location up to a point at or above the height of the entry point to the guide path, the belt loop being located such that rods lifted from the storage rack and carried upwards by the lifting fingers, up to and around the upper pulley, are deposited onto the guide path at the entry point thereof.

9. The apparatus of claim 8, wherein the lifting fingers have free ends which curve upwardly when in a rod lifting orientation.

10. The apparatus of claim 8, further comprising a drive means connected to at least one of the pulley means for driving the belt loop.

11. The apparatus of claim 10, wherein the drive means is a motor.

12. The apparatus of claim 8, wherein the storage rack is a separate and removable element with respect to the frame.

13. The apparatus of claim 8, wherein the storage rack comprises storage fingers for releasably retaining the rods within a lifting plane of the lifting fingers, said storage fingers being deflectable in an upward direction as transferred rods are carried upward by the lifting fingers.

14. The apparatus of claim 12, wherein the storage rack resides within a refrigerated or insulated cabinet.

15. The apparatus of claim 11, wherein the belt loop and drive means reside within the frame.
